(19) United States
(12) Patent Application Publication
(10) Pub. No.: US 2009/0048723 A1
(43) Pub. Date: Feb. 19, 2009

(54) Proactive optical wind shear protection and ride quality improvement system

(75) Inventors: Mark R. Nugent, Torrance, CA (US); Massoud Sinai, Santa Monica, CA (US)

Correspondence Address: Boeing (TLG);c/o Toler Law Group, 8500 Bluffstone Cove, Suite A201, Austin, TX, 78759, US

(73) Assignee: The Boeing Company

(21) Appl. No.: 12/004,555

(22) Filed: Dec. 21, 2007

Related U.S. Application Data
(63) Continuation of application No. 11/061,705, filed on Feb. 17, 2005.
Application No. 11/061,705 is a continuation-in-part of application No. 10/633,353, filed on Jul. 31, 2003, now abandoned.
Application No. 10/633,353 is a continuation-in-part of application No. 10/633,346, filed on Jul. 31, 2003, now Pat. No. 6,871,816.

(51) Int. Cl. G05D 1/00

(52) U.S. Cl. 701/10; 244/76 C

(57) ABSTRACT

Embodiments of the present invention automatically compensate control of an aircraft for an environmental condition, such as turbulence or wind shear. A sensor is configured to sense speed of air relative to an aircraft at a predetermined distance in front of the aircraft. A processor is coupled to receive the sensed speed of air from the sensor. The processor includes a first component configured to determine whether the speed of the air at the predetermined distance is indicative of an environmental condition, such as turbulence or wind shear. A second component is configured to automatically generate control signals for controlling the aircraft such that the environmental condition is automatically compensated by a time the aircraft enters the environmental condition.

### CROSS-REFERENCE TO RELATED APPLICATIONS

This application is a Continuation-in-part of application Ser. No. 10/633,353 filed on Jul. 31, 2003 and application Ser. No. 10/633,346 filed on Jul. 31, 2003, the contents of both of which are incorporated by reference.

### FIELD OF THE INVENTION

The present invention relates generally to avionics and, more specifically, to flight control avionics.

### BACKGROUND OF THE INVENTION

Various types of aircraft follow a predetermined trajectory during flight for a variety of reasons. For example, a missile follows a predetermined trajectory to reduce errors in the missile's point of impact. In this example, improving impact error results in a performance improvement for the missile and a safety improvement by possibly reducing any unintended collateral damage that may result from an erroneous impact point.

Other aircraft also follow predetermined trajectories. For example, unmanned air vehicles, such as drones, follow predetermined trajectories to a point of interest where operations, such as reconnaissance operations, may be conducted. In this case, the aircraft follows the predetermined trajectory to reduce errors in reconnaissance or surveillance data gathered by the aircraft as well as improve aircraft performance.

In this context, variations in speed of the air relative to an aircraft can cause development of conditions of varying severity. For example, aircraft frequently encounter turbulence during flight. When an aircraft that is following a trajectory enters turbulence, the turbulence can displace the flight path of the aircraft from the predetermined trajectory. Current sensing systems for velocity of air relative to an aircraft cannot look ahead of the aircraft. Current sensors include pitot tubes and, therefore, are reactive to pressure of air in which the airplane is flying. As a result, when an aircraft that is following a predetermined trajectory encounters turbulence and its flight path is displaced from the predetermined trajectory that it is following, any correction for displacement from the trajectory is reactive. Therefore, a potential is created for operational errors and sub-optimal aircraft performance.

It would be desirable to proactively correct for turbulence in an aircraft that is following a predetermined trajectory. However, there is an unmet need in the art for a system that proactively corrects for turbulence in an aircraft that is following a trajectory.

Furthermore, manned aircraft frequently encounter turbulence during flight. In order to increase the comfort of passengers and flight crews, it is desirable to minimize effects of turbulence on aircraft. However, currently known attempts to mitigate effects of turbulence are reactive. For example, seats in the aircraft may move up and down to compensate for turbulence. However, such an approach is complicated, expensive, and adds significant weight to an aircraft.

More commonly, pilots report occurrences of turbulence when the turbulence is encountered. Air traffic control relays information regarding the reported turbulence to en route aircraft. Pilots of aircraft approaching the reported turbulence use information relayed by air traffic control to avoid the reported turbulence, such as by flying around areas of reported turbulence.

Therefore, currently known attempts to mitigate effects of turbulence are reactive and either expensive, complicated, and heavy, or rely upon empirically-determined information that may be outdated when the turbulence is eventually encountered.

A more severe condition that may be encountered is severe turbulence, such as clear air turbulence, or wind shear. Clear air turbulence can cause aircraft to gain or lose noticeable amounts of altitude rapidly. In severe cases, items that are not securely stowed or, in extremely severe cases, passengers or flight crew who are not wearing seat belts, may be moved about the aircraft's cabin. For such severe cases of turbulence, the seat-mounted approach to turbulence mitigation would be ineffective. Therefore, mitigating effects of clear air turbulence currently depend upon avoidance of areas of reported turbulence. Unfortunately, occurrences of clear air turbulence are most likely unreported.

Currently known systems and methods for mitigating effects of wind shear are also reactive. During approach, an aircraft is flying at a high angle-of-attack and, as a result, is closer to stall conditions. In a typical condition in which wind shear may arise, an aircraft may experience a significant head wind upon final approach near the landing point. Because a significant head wind may increase amount of lift, a pilot may decrease speed of the aircraft to decrease lift and, consequently, altitude. However, as the aircraft continues its landing approach, the aircraft may pass completely through the head wind and may experience a significant tail wind. Further, in some wind shear scenarios, a significant downward component to a wind shear event may be encountered. If airspeed were reduced upon encountering the headwind, then airspeed of the aircraft may be close to stall speed when the tailwind is encountered. In rare cases, the aircraft may have no air speed whatsoever. As a result, the aircraft may begin to lose altitude rapidly. If a significant downward component of the wind shear is present, a catastrophic loss of the aircraft may occur.

Currently known wind shear protection systems are also reactive. Current wind shear protection systems typically sense wind shear conditions using a light detection and ranging (LIDAR) system. This gives an indication of impending wind shear, but not precise or timely measurements of wind velocity or direction. Current LIDAR-based systems alert the flight crew of existence of the wind shear condition. The flight crew relies upon its training to perform immediate actions to overcome wind shear on such a warning, such as increasing thrust by placing thrust levers in the take-off position.

Because of the wide range of conditions that may be encountered from minor turbulence that can cause passenger discomfort to severe turbulence that can cause passenger injury to wind shear that can cause catastrophic loss of an aircraft, it would be desirable to proactively compensate control of an aircraft for these conditions. However, there is an unmet need in the art for a system that proactively compensates control of an aircraft for environmental conditions.

### SUMMARY OF THE INVENTION

Embodiments of the present invention provide systems and methods for proactively protecting against wind shear and severe turbulence as well as improving ride quality of an aircraft. By detecting and proactively responding to wind shear and turbulence, the present invention automatically compensates control of an aircraft for wind shear or turbulence as the aircraft encounters the wind shear or turbulence. By proactively compensating control of the aircraft as the aircraft enters the wind shear or turbulence instead of alerting the flight crew to respond to these conditions, the present invention mitigates effects of turbulence to improve ride quality for passengers and flight crews as well as increases safety of flight during severe turbulence and wind shear conditions.

Embodiments of the present invention automatically compensate control of an aircraft for an environmental condition, such as turbulence or wind shear. A sensor is configured to sense speed of air relative to an aircraft at a predetermined distance in front of the aircraft. A processor is coupled to receive the sensed speed of air from the sensor. The processor includes a first component configured to determine whether the speed of the air at the predetermined distance is indicative of an environmental condition, such as turbulence or wind shear. A second component is configured to automatically generate control signals for controlling the aircraft such that the environmental condition is automatically compensated by a time the aircraft enters the environmental condition.

In one aspect of the present invention, turbulence is compensated, thereby improving ride quality for passengers and flight crews. According to this aspect, control surfaces are controlled by the control signals to compensate for the turbulence.

According to another aspect of the present invention, wind shear is compensated, thereby increasing flight safety. According to this aspect, the control signals cause engine thrust to be increased to compensate for the wind shear by the time the aircraft enters the wind shear.

According to a further aspect, the airspeed is sensed by an optical sensor, such as a laser.

According to another aspect, the speed of the air is sensed for turbulence at a relatively short distance in front of the aircraft, such as without limitation, a distance on the order of around 200 feet. Likewise, the airspeed is sensed for wind shear at a farther distance in front of the aircraft, such as without limitation a distance on the order of around 10,000 meters.

### BRIEF DESCRIPTION OF THE DRAWINGS

FIG. 1A is a side view of an in-flight aircraft sensing speed of the air according to one embodiment of the present invention;

FIG. 1B is a side view of an in-flight missile sensing speed of the air according to an embodiment of the present invention;

FIG. 1C is a side view of a launch vehicle sensing speed of the air according to an embodiment of the present invention;

FIG. 2 is a block diagram of a system of an embodiment of the present invention;

FIG. 3 is a graph of circle error probability;

FIG. 4 is a side view of an in-flight aircraft sensing speed of the air according to one embodiment of the present invention;

FIG. 5A is a block diagram of a system of one embodiment of the present invention;

FIG. 5B is a graph of normal acceleration;

FIG. 6 is a side view of a landing aircraft sensing speed of the air according to another embodiment of the present invention;

FIG. 7A is a block diagram of a system according to another embodiment of the present invention;

FIG. 7B is a graph of angle of attack;

FIG. 8 is a side view of an in-flight aircraft sensing speed of the air according to another embodiment of the present invention; and

FIG. 9 is a block diagram of a system according to another embodiment of the present invention.

### DETAILED DESCRIPTION OF THE INVENTION

By way of overview, embodiments of the present invention automatically correct flight path of an aircraft onto a predetermined trajectory. A sensor is configured to sense speed of air relative to the aircraft at a predetermined distance in front of the aircraft. A navigation system is configured to determine displacement of a flight path of the aircraft from the predetermined trajectory. A processor is coupled to receive the sensed speed of air from the sensor and the displacement of the flight path from the navigation system. The processor includes a first component that is configured to determine whether the speed of the air at the predetermined distance is indicative of turbulence, and a second component that is configured to automatically generate control signals to correct the flight path of the aircraft from the displacement onto the predetermined trajectory by a time when the aircraft enters the turbulence.

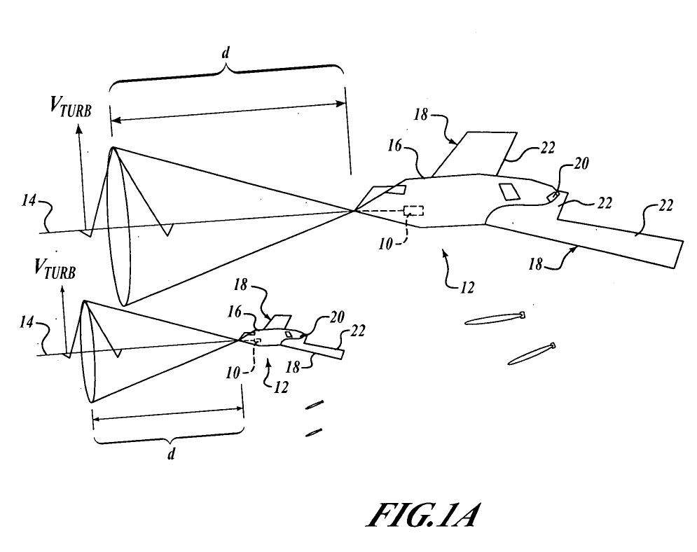

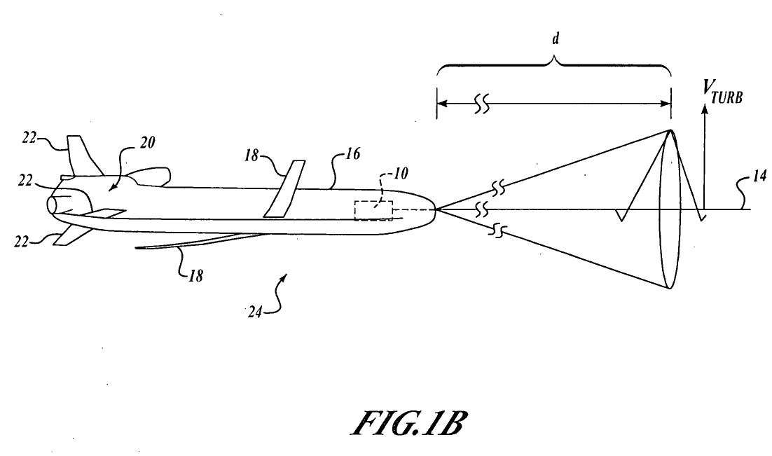

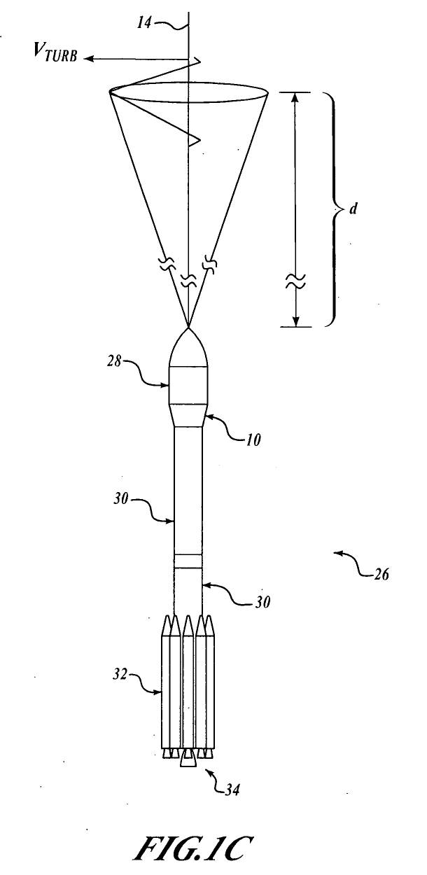

Referring now to FIG. 1A, an exemplary system 10 according to an embodiment of the present invention enables aircraft 12 to automatically correct flight path of the aircraft 12 onto a predetermined trajectory 14 by compensating for turbulence, thereby increasing operational accuracy of the aircraft 112 and improving flight performance of the aircraft 12. The sensor (not shown) senses speed and direction of air relative to the aircraft 12 at a distance d in front of the aircraft 12. In this exemplary system 10, the distance d is suitably a relatively short distance in front of the aircraft 12. For example, the distance d may be less then 1,000 meters. In one embodiment, the distance d is around 100 feet. However, it will be appreciated that any distance d may be selected as desired for a particular application. As is known, the speed of the air is an air mass velocity that is a vector quantity. The speed of the air is a vector velocity that includes a component Vᵤ along the X direction, a component Vᵥ along the Y direction, and a component V_{w} along the Z direction. For sake of clarity, the component V_{w} is the only component shown in FIG. 1A (and in all other FIGURES, as well) and is labeled as V_{turb}.

As will be explained in detail below, the system 10 generates control signals that cause control of the aircraft 12 to be compensated for detected turbulence to correct the flight path onto the trajectory 14 when the aircraft 12 enters the detected turbulence. As shown in FIG. 1A, more than one of the aircraft 12 suitably may be flying in formation by following its own predetermined trajectory 14. As is known, the aircraft 12 includes a fuselage 16, a pair of wings 18, and at least one engine 20. As is also known, the aircraft 12 includes control surfaces 22. Given by way of nonlimiting example, the aircraft 12 includes an unmanned air vehicle, such as the X-45 Unmanned Combat Air Vehicle manufactured by The Boeing Company. The control surfaces in the exemplary aircraft 12 shown in FIG. 1A include ailerons and elevons for controlling roll, pitch, and yaw. However, it will be appreciated that other types of aircraft 12 may include the system 10, and that the control surfaces 22 may be provided depending on the type of the aircraft 12. For example, the aircraft 12 may include without limitation other types of manned or unmanned air vehicles, such as drones or the like, that may include control surfaces 22 such as ailerons, elevators, and a rudder for controlling roll, pitch, and yaw, respectively.

The term “aircraft” is not intended to be limited to fixed wing airplanes, but instead is intended to include all air vehicles. To that end, other types of air vehicles may include the system 10 as desired. Referring now to FIG. 1B, a missile 24 includes the system 10 for automatically correcting flight path onto the trajectory 14 when turbulence detected at the distance d is entered. The missile 24 may be any type of missile, such as without limitation a Conventional Air Launched Cruise Missile manufactured by The Boeing Company. As is known, the missile 24 includes a fuselage 16, an engine 20 such as a turbojet engine, and control surfaces 22 such as fins. In the nonlimiting example shown in FIG. 1B, a pair of wings 18 is optionally provided.

Referring now to FIG. 1C, given by way of another nonlimiting example, a rocket 26, such as without limitation a launch vehicle like a Delta II launch vehicle manufactured by The Boeing Company, includes the system 10 for correcting flight path of the rocket 26 onto the trajectory 14 when turbulence detected at the distance d is entered. It will be appreciated that correcting the flight path of the rocket 26 for turbulence is applicable up to altitudes of around 100,000 feet or less. As a result, the system 10 corrects the flight path for turbulence during the ascent phase of the flight profile of the rocket 26. As is known, the rocket 26 includes a payload faring 28, fuel tanks 30, strap-on motors 32, and a main engine 34. However, it will be appreciated that any type of rocket may include the system 10 as desired.

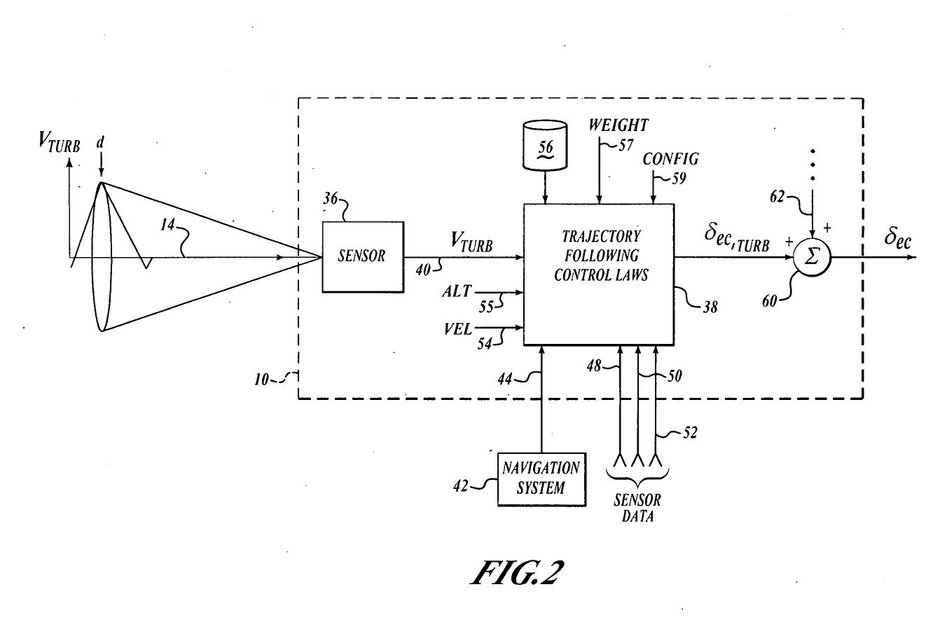

Referring now to FIG. 2, a sensor 36 senses the speed and direction of the air relative to the air vehicle, such as the aircraft 12 (FIG. 1A), the missile 24 (FIG. 1B), the rocket 26 (FIG. 1C), or the like, at the distance d in front of the air vehicle. The sensor 36 is suitably any sensing system that is configured to sense speed and direction of the air in front of an air vehicle. In one presently preferred embodiment, the sensor 36 is an optical sensor, such as a laser-based optical air data sensor. An exemplary optical air data sensor that is well-suited for the sensor 36 is a laser Doppler velocimeter available from Optical Air Data Systems, L.P. The laser Doppler velocimeter is described in U.S. Pat. No. 5,272,513, the contents of which are hereby incorporated by reference. Advantageously, the sensor 36 provides a capability to “look ahead” of the air vehicle that permits turbulence to be detected in front of the air vehicle at the distance d. This look-ahead capability permits the system 10 to proactively compensate for turbulence in correcting the flight path of the air vehicle onto the desired trajectory 14 by a time when the air vehicle enters the turbulence.

Trajectory following control laws 38 receives from the sensor 36 a signal 40 that is indicative of the speed of the air relative to the air vehicle at the distance d in front of the air vehicle. The trajectory following control laws 38 also receive a signal 54 that is indicative of velocity of the air vehicle. The trajectory following control laws 38 are implemented within a flight control laws processor. The flight control laws processor is suitably any acceptable flight management computer or the like that is configured to perform calculations and process signals indicative of various flight-related parameters. Flight management computers are well known in the art, and a detailed description of its construction and operation is not necessary for an understanding of the invention.

The trajectory following control laws 38 receives from a navigation system 42 a set of signals 44 that provide information regarding the actual flight path, and positions, attitudes and their rates, of the air vehicle. Navigation systems that generate signals representing the flight path, and positions, attitudes and their rates, of the air vehicle are well known. As a result, an explanation of details of construction and operation of the navigation system 42 is not necessary for an understanding of the present invention.

The trajectory following control laws 38 receives from known sensors (not shown) signals 48, 50, and 52 that are indicative of roll rate, pitch rate, and yaw rate, respectively. A signal 54 that is indicative of velocity of the air vehicle and a signal 55 that is indicative of altitude of the air vehicle are also supplied to the trajectory following control laws 38 from known sensors. If desired, signals 57 and 59 that are indicative of weight of the air vehicle and configuration of the air vehicle, respectively, may be provided to the trajectory following control laws 38. The trajectory following control laws 38 suitably are implemented in any acceptable flight control computer or the like that is configured to perform calculations and process signals indicative of various flight-related parameters. Flight control computers are well known in the art, and a detailed description of its construction and operation is not necessary for an understanding of the invention.

The trajectory following control laws 38 generates turbulence deflection commands δ_{ec, turb,} which are to be inserted into the existing flight control laws of the vehicle. As is known, a set of flight control laws for the air vehicle is stored in storage 56, such as a memory device, a magnetic or optical disk, a CD-ROM, or the like. The flight control computer retrieves the set of flight control laws from storage 56 and applies position error to the flight control laws. In addition, the flight control laws 38 applies pitch rate, roll rate, and yaw rate (from the signals 48, 50, and 52, respectively) to the control laws. Applying the signals 44, 48, 50, and 52 to the control laws results in a known correction of flight path of an air vehicle that is displaced from a trajectory back onto the trajectory.

It will be appreciated that the known portion of correction of the flight path based on the signals 44, 48, 50, and 52 as described above takes into account position error. Advantageously, according to the present invention, the system 10 also proactively includes effects of turbulence into correction of the flight path back onto the trajectory. The trajectory following control laws 38 retrieves the set of control laws from storage 56 and applies the signal 40 that is indicative of the speed of the air relative to the air vehicle to the control laws for the air vehicle.

Advantageously, the trajectory following control laws 38 takes into account the velocity of the air vehicle via the signal 54. As a result, the turbulence deflection commands δ_{ec, turb} are output by the trajectory following control laws 38 at a time such that the control surfaces of the air vehicle have already been positioned to compensate for the sensed turbulence according to the control laws for the air vehicle by the time the air vehicle travels the distance d at the velocity at which the air vehicle is traveling.

The trajectory following control laws 38 applies the signals 44, 48, 50, 52, 40, 54, 55, 57, and 59 as described above to generate the turbulence deflection commands δ_{ec, turb} to correct flight path of the air vehicle from a displacement back onto the trajectory 14. Advantageously, the turbulence deflection commands δ_{ec, turb} are output at a time such that the control surfaces of the air vehicle are positioned to compensate for the sensed turbulence according to the control laws for the air vehicle by the time the air vehicle travels the distance d at the velocity indicated by the signal 54. As a result, correction of the flight path of the air vehicle back onto the trajectory 14 advantageously is compensated for detected turbulence by the time the air vehicle travels the distance d and enters the detected turbulence. Because the control surfaces of the air vehicle are already positioned to compensate for detected turbulence when the air vehicle enters the detected turbulence, any effects of the turbulence advantageously are mitigated by proactive position of the control surfaces as described above.

The turbulence deflection commands δ_{ec, turb} are added to the surface commands within the flight control laws. The flight control laws generates control surface deflection commands δ_{ec} in any acceptable known manner. The flight control laws includes a summer 60. The turbulence deflection commands δ_{ec, turb} are supplied to one input of the summer 60. Signals 62 are provided from the flight control laws for the control surfaces 22 (FIGS. 1A, 1B and 1C) to another input of the summer 60.

The following nonlimiting example of operation of the system 10 is provided for illustrative purposes only. In one nonlimiting example, an air vehicle is traveling at a velocity and is below its trajectory 14. At the distance d in front of the air vehicle, V_{turb} is detected with a positive component that tends to exert an upward force on the air vehicle. The flight control laws processor 38 retrieves and applies the signals 44, 48, 50, and 52 that are indicative of position error, roll rate, pitch rate, and yaw rate, respectively, to the control laws for the air vehicle. The trajectory following control laws 38 also applies the signals 40, 54, 55, 57, and 59 that are indicative of V_{turb}, air vehicle velocity, air vehicle altitude, air vehicle weight, and air vehicle configuration, respectively, to the control laws for the air vehicle. As a result, the surface deflection commands δ_{ec} cause the control surfaces 22 (FIGS. 1A, 1B, and 1C) to respond to the turbulence deflection commands δ_{ec, turb} to correct the flight path of the air vehicle upwardly onto the trajectory 14. Advantageously, at a time when the air vehicle enters the detected turbulence, the turbulence deflection commands δ_{ec, turb} cause the control surfaces 22 (FIGS. 1A, 1B, and 1C) to respond to the surface deflection commands δ_{ec} to compensate for the detected turbulence. It will be appreciated that correcting the flight path upwardly onto the trajectory 14 and simultaneously entering turbulence that exerts an upward force could cause the correction to overshoot the trajectory 14 if turbulence were not compensated. Advantageously, according to the present invention, compensating for the detected turbulence in this nonlimiting example prevents the air vehicle from overshooting above the trajectory 14.

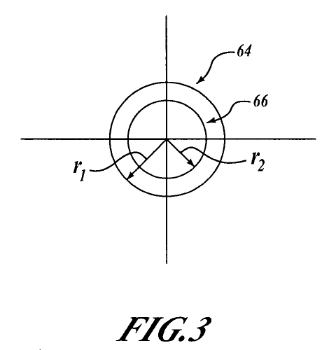

Referring now to FIG. 3, it will be appreciated that the present invention advantageously reduces the circle of error probability, that is a measure of accuracy with which an air vehicle, such as a rocket or missile, can be guided. Without benefit of the system 10, turbulence can only be compensated reactively after the air vehicle is displaced from the trajectory being followed. This results in a circle of error probability 64 having a radius r₁ within which 50% of reliable shots land within a predetermined distance of the target. However, it will be appreciated that automatically and proactively compensating for turbulence when correcting flight path of an air vehicle onto its predetermined trajectory, as described above, results in a circle of error probability 66 having a radius r₂ that is smaller than the radius r₁. That is, proactively compensating for turbulence when correcting trajectory of an air vehicle increases operational accuracy of the air vehicle.

Furthermore, and by way of overview, embodiments of the present invention automatically compensate control of an aircraft, such as a manned aircraft, for an environmental condition, such as turbulence or wind shear. A sensor is configured to sense speed of air relative to an aircraft at a predetermined distance in front of the aircraft. A processor is coupled to receive the sensed speed of air from the sensor. The processor includes a first component configured to determine whether the speed of the air at the predetermined distance is indicative of an environmental condition, such as turbulence or wind shear. A second component is configured to automatically generate control signals for controlling the aircraft such that the environmental condition is automatically compensated by a time the aircraft enters the environmental condition.

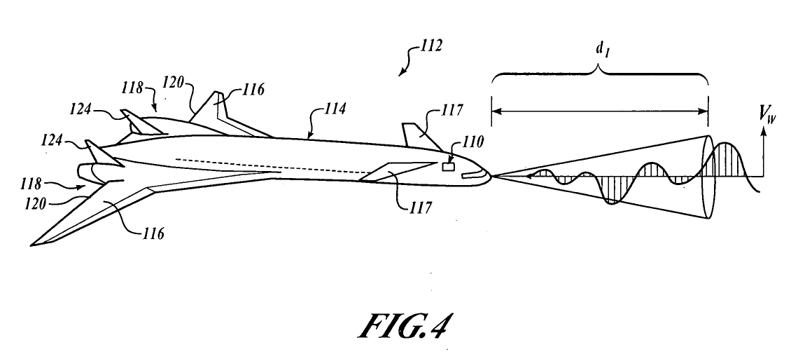

Referring now to FIG. 4, an exemplary system 110 according to one embodiment of the present invention enables an aircraft 112 to proactively compensate control of the aircraft 112 for turbulence, thereby increasing ride comfort for passengers and flight crew of the aircraft 112. The sensor (not shown) senses speed and direction of air relative to the aircraft 112 at a distance d₁ in front of the aircraft 112. In this exemplary system 110, the distance d₁ is suitably a relatively short distance in front of the aircraft 112. For example, the distance d₁ may be less then 1,000 meters. In one embodiment, the distance d₁ is around 200 feet. However, it will be appreciated that any distance d₁ may be selected as desired for a particular application. As is known, the speed of the air is an air mass velocity that is a vector quantity. The speed of the air is a vector velocity that includes a component Vᵤ along the X direction, a component Vᵥ along the Y direction, and a component V_{w} along the Z direction. For sake of clarity, the component V_{w} is the only component shown in FIG. 4 (and in all other FIGURES, as well). The component V_{w} is a vector component for compensating turbulence to increase ride quality because this is the vector component that is most responsible for causing the aircraft to generate undesirable normal accelerations.

As will be explained in detail below, the system 110 generates control signals that cause control of the aircraft 112 to be compensated for detected turbulence when the aircraft 112 enters the detected turbulence. As is known, the aircraft 112 includes a fuselage 114, a pair of wings 116, and at least one engine 118. A pair of canards 117 may be provided, if desired. As is also known, the aircraft 112 includes control surfaces, such as ailerons 120, trailing edge flaps (not shown), leading edge slats (not shown), and a rudder 124. Advantageously, when the canards 117 are provided, direct lift can be generated. That is, lift can be developed on the aircraft 112 without creating a significant amount of pitching moment. Direct lift can be generated in a number of ways known to those skilled in the art. In the exemplary aircraft 112, the canards 117 and aft horizontal control surfaces, such as the flaps (not shown) cooperate in a blended manner to create direct lift without a significant pitching moment.

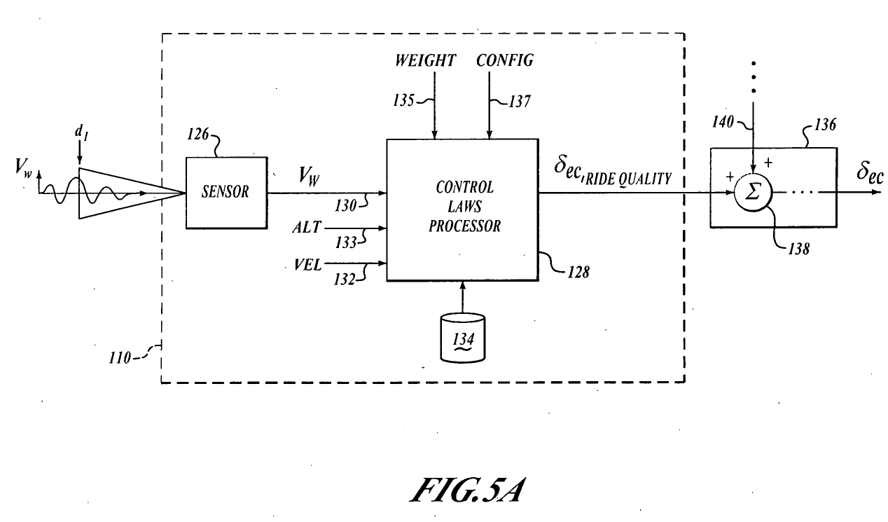

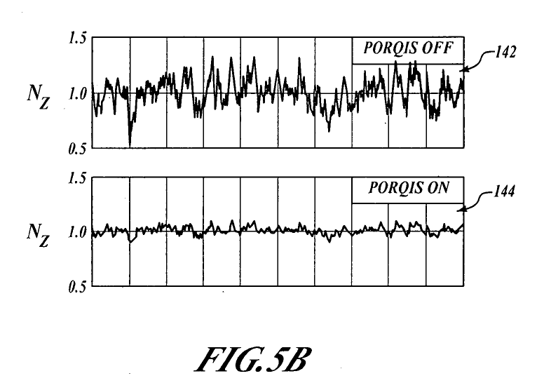

Referring now to FIG. 5A, a sensor 126 senses the speed of the air relative to the aircraft 112 (FIG. 4) at the distance d₁ in front of the aircraft 112. The sensor 126 is suitably any sensing system that is configured to sense speed of the air in front of an aircraft. In one presently preferred embodiment, the sensor 126 is an optical sensor, such as a laser-based optical air data sensor. An exemplary optical air data sensor that is well-suited for the sensor 126 is a laser Doppler velocimeter available from Optical Air Data Systems, L.P. The laser Doppler velocimeter is described in U.S. Pat. No. 5,272,513, the contents of which are hereby incorporated by reference. Advantageously, the sensor 126 provides a capability to “look ahead” of the aircraft 112 that permits turbulence to be detected in front of the aircraft 112 at the distance d₁. This look-ahead capability permits the system 110 to proactively compensate for turbulence by a time when the aircraft 112 enters the turbulence.

A flight control laws processor 128 receives from the sensor 126 a signal 130 that is indicative of the speed of the air relative to the aircraft 112 at the distance d₁ in front of the aircraft 112. The control laws processor 128 also receives a signal 132 that is indicative of velocity of the aircraft 112. The control laws processor 128 also receives a signal 133 indicative of altitude of the aircraft 112. If desired, signals indicative of weight of the aircraft 112 and configuration of the aircraft 112 may be provided to the control laws processor 128. The control laws processor 128 is suitably any acceptable flight control computer or the like that is configured to perform calculations and process signals indicative of various flight-related parameters. Flight control computers are well known in the art, and a detailed description of its construction and operation is not necessary for an understanding of the invention.

The control laws processor 128 generates ride quality deflection commands δ_{ec, ride quality,} which is to be distributed among the control surfaces in a manner that creates direct lift. As is known, a set of control laws for the aircraft 112 are stored in storage 34, such as a memory device, a magnetic or optical disk, a CD-ROM, or the like. The control laws processor 128 retrieves the set of control laws from storage 134 and applies the signal 130 that is indicative of the speed component V_{W} to the control laws for the aircraft 112. However, according to the present invention the control laws are modified by the control laws processor 128. For example, in one embodiment the speed component V_{w} is passed through the following Laplace domain transfer function:

$${δ}_{ec , ride quality} = \frac{Kp \cdot s}{s + Kd}$$

where
Kp is a gain factor that is a function of aircraft velocity; and
Kd is a gain factor that is a function of aircraft altitude.

The gain factors Kp and Kd are stored in storage 134 as a function of aircraft velocity and aircraft altitude, respectively. However, it will be appreciated that each of the gain factors Kp and Kd may be functions of both velocity and altitude. The desired gain factors Kp and Kd are retrieved from storage 134 based upon aircraft velocity and aircraft altitude, respectively, in response to the signals 132 and 133, respectively. However, it will be appreciated that the gain factors Kp and Kd may also be stored as functions of other independent variables, such as weight of the aircraft 112 and configuration of the aircraft 112, and retrieved from storage 134 in response to signals 135 and 137, respectively.

Advantageously, the control laws processor 128 takes into account the velocity of the aircraft 112 via the signal 132. As a result, the ride quality deflection commands δ_{ec, ride quality} are output by the control laws processor 128 at a time such that the control surfaces of the aircraft 112 have already been positioned to compensate for the sensed turbulence according to the control laws for the aircraft 112 by the time the aircraft 112 travels the distance d₁ at the velocity at which the aircraft 112 is traveling. As a result, control of the aircraft 112 advantageously is compensated for detected turbulence by the time the aircraft 112 travels the distance d₁ and enters the detected turbulence. Because the control surfaces of the aircraft 112 are already positioned to compensate for detected turbulence when the aircraft 112 enters the detected turbulence, any effects of the turbulence advantageously are mitigated by proactive positioning of the control surfaces as described above.

The ride quality deflection commands δ_{ec, ride quality} are provided to a pitch control device command processor 136. The pitch control device command processor 136 generates pitch control surface deflection commands δ_{ec} in any acceptable known manner. The pitch control device command processor 136 includes a summer 138. The ride quality deflection commands δ_{ec, ride quality} are supplied to one input of the summer 138. Signals 140 are provided from actuators for the control surfaces to another input of the summer 138. The pitch control device command processor 136 performs final development of a pitch control device command and suitably may be implemented within the control laws processor 128.

When the aircraft 112 uses more than one control surface (such as the canards 117 and the aft horizontal control surfaces) to generate direct lift, the pitch control surface deflection commands δ_{ec} are distributed among those control surfaces. However, when the aircraft 112 has only one pitch effector, such as an elevator, the pitch control surface deflection commands δ_{ec} are added to a surface deflection command within existing flight control laws that is otherwise used in a known manner to control pitch of the aircraft 112.

Referring now to FIG. 5B, a comparison is shown for normal acceleration N_{Z} without benefit of the system 110 and with the system 110. A graph 142 shows normal acceleration N_{Z} without use of the system 110 as an aircraft flies through turbulence. The graph 142 includes several high amplitude peaks that correspond to turbulence events encountered by the aircraft. As a result, the graph 142 indicates numerous events that introduce discomfort to passengers and the flight crew of the airplane. To the contrary, a graph 144 shows normal acceleration N_{Z} when the system 110 is in operation. Advantageously, the system 110 operates as described above to compensate turbulence. As a result, the graph 144 does not include the peaks in normal acceleration that the graph 142 includes. Perturbations indicated in the graph 144 instead are indicative of small amplitude disturbances. Advantageously, humans can withstand the small amplitude disturbances shown in the graph 144 for long periods of time.

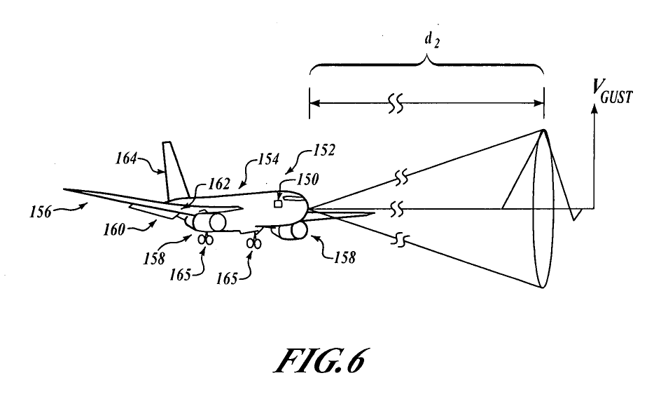

Referring now to FIG. 6, an exemplary system 150 according to another embodiment of the present invention enables an aircraft 152 to proactively sense and compensate for wind shear, such as during landing. As is well known, the aircraft 152 includes a fuselage 154, a pair of wings 156, and engines 158. As is also well known, the aircraft 152 includes control surfaces, such as trailing edge flaps 160, leading edge slats 162, and a rudder 164. As depicted in FIG. 6, the aircraft 152 is configured for landing. As such, landing gears 165 are down, and the flaps 160 and the slats 162 are extended. Because the aircraft 152 is landing, the aircraft 152 is following a glide slope downwardly at a high angle-of-attack toward a landing point on a runway (not shown). It will be appreciated that the system 150 also could be implemented on other aircraft with different configurations. For example, the system 150 suitably may be implemented on the aircraft 112 (FIG. 4) or any other aircraft configuration as desired.

The system 150 advantageously senses speed and direction of air relative to the aircraft 152 (and, specifically, the speed component V_{W}, denoted as V_{gust}) at a distance d₂ in front of the aircraft. In the exemplary embodiment of the system 150, the speed of the air relative to the aircraft 152 (that is, V_{gust}) is sensed at a relatively long distance in front of the aircraft 152 for occurrences of wind shear. In order to proactively compensate for wind shear conditions, it is desirable to sense speed of the air for wind shear at relatively long distances in front of the aircraft 152. Accordingly, the distance d₂ is suitably farther than 1,000 meters in front of the aircraft. In one present embodiment, the distance d₂ is around 10,000 meters. Detecting gusts due to wind shear at relatively far distances in front of the aircraft 152 affords the system 150 sufficient time to configure control of the aircraft 152 sufficiently to compensate for the wind shear by a time when the wind shear is entered.

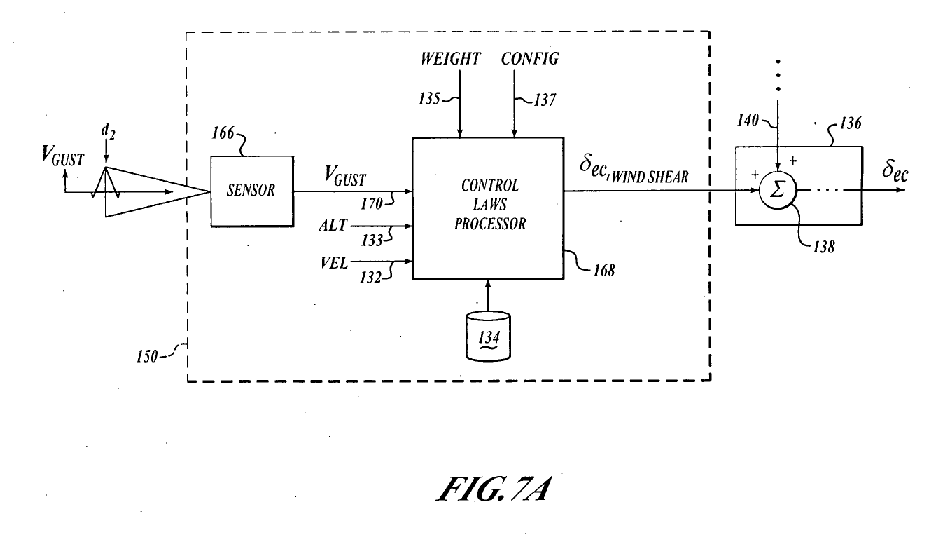

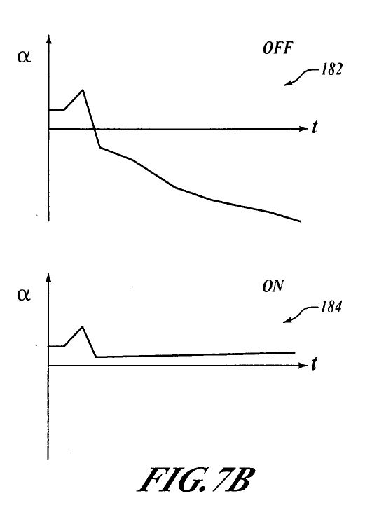

Referring now to FIG. 7A, the system 150 includes components that are similar to components of the system 110. Therefore, for sake of clarity and brevity, details of components of the system 150 need not be repeated for an understanding of the present invention. A sensor 166 is similar to the sensor 126 (FIG. 5A), except that the sensor 166 is configured to detect speed V_{gust} at the distance d₂. A control laws processor 168 is similar to the control laws processor 128 (FIG. 5A). The control laws processor 168 receives from the sensor 166 a signal 170 that is indicative of the speed V_{gust}. The control laws processor also receives the signal 132 that is indicative of aircraft velocity and the signal 133 that is indicative of aircraft altitude. If desired, the control laws processor 168 may receive the signals 135 and 137 indicative of aircraft weight and aircraft configuration, respectively. The control laws processor 168 is also coupled to the storage device 134 for retrieval of aircraft flight control laws.

In a similar manner to the control laws processor 128 (FIG. 5A), the control laws processor 168 generates wind shear deflection commands δ_{ec, wind shear} by applying the speed V_{gust} to the aircraft flight control laws. The control laws processor 168 retrieves the set of flight control laws from storage 134 and applies the signal 170 that is indicative of the speed component V_{gust} to the control laws for the aircraft 112. The flight control laws are modified by the control laws processor 168 in a manner similar to the control laws processor 128.

Likewise, the control laws processor 168 applies the aircraft velocity to the aircraft control laws so the aircraft 152 is compensated for the detected wind shear when the aircraft 152 enters the detected wind shear. By way of nonlimiting example, the control laws processor 168 may generate the wind shear deflection commands δ_{ec, wind shear} that cause control surfaces, such as the flaps 160 and/or the slats 162 (FIG. 6) to be extended or retracted accordingly. In addition, thrust commands are also sent to the engines 158 in preparation for entering the wind shear. Furthermore, the wind shear deflection commands δ_{ec, wind shear} and the thrust commands are generated in an appropriate time by taking into consideration the aircraft velocity so the control surfaces are already positioned appropriately and the engine thrust is adjusted appropriately when the aircraft 152 enters the wind shear detected by the sensor 166.

Like the ride quality deflection commands δ_{ec, ride quality} generated by the control laws processor 128 (FIG. 5A), the wind shear deflection commands δ_{ec, wind shear} generated by the control laws processor 168 are input to the pitch control device command processor 136. It will be appreciated that the pitch control device command processor 136 suitably commands position of the flaps 160 and the slats 162 (FIG. 6). In addition, engine thrust commands are input to a suitable engine control system.

Referring now to FIG. 7B, a graph 182 shows angle of attack α without benefit of the system 150 during a wind shear event. In this case, the aircraft stalls, which may lead to catastrophic loss of the aircraft. A graph 184 shows angle of attack α with the system 150 in use during a wind shear event. In this case, the aircraft advantageously does not stall, and catastrophic loss of the aircraft is avoided.

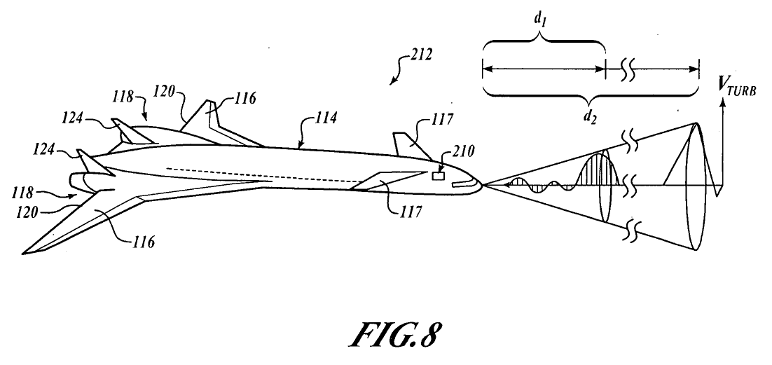

Referring now to FIG. 8, an exemplary system 210 according to another embodiment of the present invention permits an aircraft 212 to sense turbulence at the distance d₁ and proactively compensate for the turbulence when the aircraft 212 enters the turbulence as well as sense severe turbulence, such as clear air turbulence, at the distance d₂ and proactively compensate for the severe turbulence when the aircraft 212 enters the severe turbulence. The system 210 advantageously improves ride quality during cruise portions of flight and also improves safety by proactively sensing and compensating for any occurrences of severe turbulence, such as clear air turbulence during the cruise portion of flight. The system 210 also proactively compensates for wind shear during landing as described above. The aircraft 212 suitably is the same as the aircraft 112 (FIG. 4), described above, except the system 210 is installed on the aircraft 212 while the system 110 (FIG. 5A) is installed on the aircraft 112 (FIG. 4).

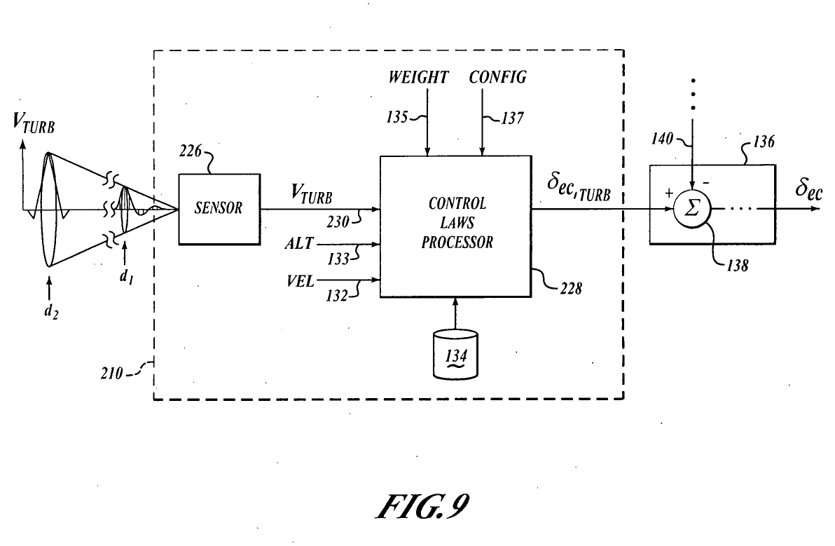

Referring now to FIG. 9, the system 210 includes a sensor 226 that is configured to sense speed and direction of the air relative to the aircraft 212 (and, specifically, the speed component V_{W}, denoted as V_{turb}) at the distance d₁ and at the distance d₂. The sensor 226 senses the speed V_{turb} at the distance d₁ for proactively compensating for routine turbulence that may be encountered during the cruise portion of flight. This aspect is described above with reference to the system 110 (FIG. 5A). The sensor 226 advantageously is also configured to sense the speed V_{turb} at the distance d₂. This permits the system 210 to also proactively sense and compensate for severe turbulence, such as clear air turbulence, that may be encountered during the cruise portion of flight or wind shear during landing.

The sensor 226 is similar to the sensor 126 (FIG. 5A) and the sensor 166 (FIG. 7A). However, the sensor 226 is configured to sense speed and direction of the air at both of the distances d₁ and d₂ in any acceptable manner. For example, in one embodiment the sensor 226 may include two optical air data sensors that include two lasers. One laser has a first focal distance for sensing speed and direction of the air at the distance d₁. Another laser suitably has a second focal distance that is different from the first focal distance for sensing the speed and direction of the air at the distance d₂.

A control laws processor 228 is similar to the control laws processor 128 (FIG. 5A) and 168 (FIG. 7A). The control laws processor 228 receives from the sensor 226 signals 230 that are indicative of V_{turb}. In addition, the control laws processor 228 receives the signal 132 indicative of aircraft velocity and the signal 133 that is indicative of aircraft altitude. If desired, the control laws processor 228 may receive the signals 135 and 137 indicative of aircraft weight and aircraft configuration, respectively. The control laws processor 228 is also coupled to the storage device 34 for retrieval of aircraft flight control laws.

The system 210 compensates for mild turbulence as described for the system 110 (FIG. 5A) and compensates for severe turbulence, such as clear air turbulence, and wind shear as described above for the system 150 (FIG. 7A). To that end, the control laws processor 228 generates turbulence deflection commands δ_{ec, turb} by applying the speed V_{turb} to the aircraft flight control laws. The control laws processor 228 retrieves the set of flight control laws from storage 134 and applies the signal 230 that is indicative of the speed component V_{turb} to the control laws for the aircraft 212. The flight control laws are modified by the control laws processor 228 in a manner similar to the control laws processors 128 and 168 (FIGS. 5A and 7A, respectively). Engine thrust commands are also generated in a timely manner as discussed above in the context of wind shear.

Likewise, the control laws processor 228 applies the aircraft velocity to the aircraft control laws so the aircraft 212 is compensated for the detected turbulence or wind shear when the aircraft 212 enters the detected turbulence or wind shear. By way of nonlimiting example, the control laws processor 228 may generate the turbulence deflection commands δ_{ec, turb} that cause control surfaces to be extended or retracted accordingly. Furthermore, the wind shear deflection commands δ_{ec, turb} and the engine thrust commands are generated at an appropriate time by taking into consideration the aircraft velocity so the control surfaces are already positioned appropriately and engine thrust is adjusted appropriately when the aircraft 212 enters the turbulence or wind shear detected by the sensor 226.

The turbulence deflection commands δ_{ec, turb} generated by the control laws processor 228 are input to the pitch control device command processor 136. When the aircraft 212 uses more than one control surface (such as the canards 117 and the aft horizontal control surfaces) to generate direct lift, the pitch control surface deflection commands δ_{ec} are distributed among those control surfaces. However, when the aircraft 212 has only one pitch effector, such as an elevator, the pitch control surface deflection commands δ_{ec} are added to a surface deflection command within existing flight control laws that is otherwise used in a known manner to control pitch of the aircraft.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. A method for automatically compensating control of an aircraft for an environmental condition, the method comprising:
sensing speed of air relative to an aircraft at a predetermined distance in front of the aircraft;
determining whether the speed of the air at the predetermined distance is indicative of an environmental condition; and
automatically compensating control of the aircraft by a time the aircraft enters the environmental condition.

15. The method of claim 14, wherein automatically compensating control of the aircraft includes automatically generating control signals.

16. The method of claim 14, wherein the environmental condition includes turbulence.

17. The method of claim 16, wherein the predetermined distance is less then 1,000 meters.

18. The method of claim 17, wherein the predetermined distance is around 200 feet.

19. The method of claim 14, wherein the environmental condition includes wind shear.

20. The method of claim 19, wherein the wind shear includes a microburst.

21. The method of claim 19, wherein the predetermined distance is greater than 1,000 meters.

22. The method of claim 21, wherein the predetermined distance is around 10,000 meters.

23. The method of claim 14, wherein automatically compensating control of the aircraft includes automatically positioning control surfaces to compensate for the environmental condition by the time the aircraft enters the environmental condition.

24. The method of claim 19, wherein automatically compensating control of the aircraft includes automatically increasing engine thrust to compensate for wind shear by the time the aircraft enters the wind shear.

25. The method of claim 14, wherein the speed of the air is sensed by an optical sensor.

26. The method of claim 25, wherein the optical sensor includes a laser.

27. The method of claim 26, wherein the laser includes a laser Doppler velocimeter system.

28. A system for automatically compensating control of an aircraft for turbulence, the system comprising:
an optical sensor configured to sense speed of air relative to an aircraft at a predetermined distance in front of an aircraft;
storage media that stores control laws for the aircraft; and
a processor coupled to receive the sensed speed of air from the optical sensor and the control laws from the storage media, the processor including:
a first component that determines whether the sensed speed of the air at the predetermined distance is indicative of turbulence; and
a second component that applies the sensed speed of the air at the predetermined distance to the control laws of the aircraft to automatically generate control signals that configure the aircraft to compensate for the turbulence by a time the aircraft enters the turbulence.

29. The system of claim 28, wherein the predetermined distance is less then 1,000 meters.

30. The system of claim 29, wherein the predetermined distance is around 200 feet.

31. The system of claim 28, wherein the control signals automatically cause flight control surfaces to be positioned to compensate for the turbulence by the time the aircraft enters the turbulence.

32. The system of claim 28, wherein the optical sensor includes a laser.

33. The system of claim 32, wherein the laser includes a laser Doppler velocimeter system.

34. A method for automatically compensating control of an aircraft for turbulence, the method comprising:
optically sensing speed of air relative to an aircraft at a predetermined distance in front of the aircraft;
determining whether the speed of the air at the predetermined distance indicative of turbulence; and
automatically compensating control of the aircraft by a time the aircraft enters the turbulence.

35. The method of claim 34, wherein automatically compensating control of the aircraft includes automatically generating control signals.

36. The method of claim 34, wherein the predetermined distance is less then 1,000 meters.

37. The method of claim 36, wherein the predetermined distance is around 200 feet.

38. The method of claim 34, wherein automatically compensating control of the aircraft includes automatically positioning control surfaces to compensate for the turbulence by the time the aircraft enters the turbulence.

39. The method of claim 34, wherein the speed of the air is optically sensed by a laser.

40. The method of claim 39, wherein the laser includes a laser Doppler velocimeter system.

41. A system for automatically compensating control of an aircraft for wind shear, the system comprising:
an optical sensor configured to sense speed of air relative to an aircraft at a predetermined distance in front of an aircraft;
storage media that stores control laws for the aircraft; and
a processor coupled to receive the sensed speed of air from the optical sensor and the control laws from the storage media, the processor including:
a first component that determines whether the sensed speed of the air at the predetermined distance is indicative of wind shear;
a second component that applies the sensed speed of the air at the predetermined distance to the control laws of the aircraft; and
a third component that modifies the control laws of the aircraft to which the sensed speed of the air at the predetermined distance has been applied to automatically generate control signals that configure the aircraft to compensate for the wind shear by a time the aircraft enters the wind shear.

42. The system of claim 41, wherein the wind shear includes a microburst.

43. The system of claim 41, wherein the predetermined distance is greater than 1,000 meters.

44. The system of claim 43, wherein the predetermined distance is around 10,000 meters.

45. The system of claim 41, wherein the control signals automatically cause engine thrust to be increased to compensate for the wind shear by a time the aircraft enters the wind shear.

46. The system of claim 41, wherein the optical sensor includes a laser.

47. The system of claim 46, wherein the laser includes a laser Doppler velocimeter system.

48. A method for automatically compensating control of an aircraft for wind shear, the method comprising:
optically sensing speed of air relative to an aircraft at a predetermined distance in front of the aircraft;
determining whether the speed of the air at the predetermined is indicative of wind shear; and
automatically compensating control of the aircraft by a time the aircraft enters the wind shear.

49. The method of claim 48, wherein automatically compensating control of the aircraft includes automatically generating control signals.

50. The method of claim 48, wherein the wind shear includes a microburst.

51. The method of claim 48, wherein the predetermined distance is greater than 1,000 meters.

52. The method of claim 51, wherein the predetermined distance is around 10,000 meters.

53. The method of claim 48, wherein automatically compensating control of the aircraft includes automatically increasing engine thrust to compensate for the wind shear by the time the aircraft enters the wind shear.

54. The method of claim 48, wherein the speed of the air is optically sensed by a laser.

55. The method of claim 54, wherein the laser includes a laser Doppler velocimeter system.

56. A system for automatically compensating control of an aircraft for turbulence or clear air turbulence or wind shear, the system comprising:
a sensor configured to sense speed of air relative to an aircraft at a first predetermined distance in front of the aircraft and at a second predetermined distance that is farther in front of the aircraft than the first predetermined distance;
storage media that stores control laws for the aircraft; and
a processor coupled to receive the sensed speed of the air from the sensor and the control laws from the storage media, the processor including:
a first component that determines whether the sensed speed of the air at the first predetermined distance is indicative of turbulence, the first component further determining whether the sensed speed of the air at the second predetermined distance is indicative of clear air turbulence or wind shear; and
a second component that applies the sensed speed of the air at the first and second predetermined distances to the control laws of the aircraft to automatically generate control signals that configure the aircraft to compensate for the turbulence or clear air turbulence or wind shear by a time the aircraft enters the turbulence or clear air turbulence or wind shear.

57. The system of claim 56, wherein the control signals automatically cause flight control surfaces to be positioned to compensate for the turbulence by a time the aircraft encounters the turbulence.

58. The system of claim 56, wherein the control signals automatically cause engine thrust to be increased to compensate for clear air turbulence by a time the aircraft enters the clear air turbulence or wind shear.

59. The system of claim 56, wherein the sensor includes an optical sensor.

60. The system of claim 59, wherein the optical sensor includes a laser.

61. The system of claim 61, wherein the laser is multiplexed between a first wavelength for sensing speed of the air at the first predetermined distance and a second wavelength for sensing speed of the air at the second predetermined distance.

62. The system of claim 59, wherein the optical sensor includes:
a first laser configured to operate at a first wavelength for sensing speed of the air at the first predetermined distance; and
a second laser configured to operate at a second wavelength for sensing speed of the air at the second predetermined distance.

63. The system of claim 56, wherein the first predetermined distance is less than 1,000 meters and the second predetermined distance is greater than 1,000 meters.

64. The system of claim 63, wherein the first predetermined distance is around 200 feet and the second predetermined distance is around 10,000 meters.

65. (canceled)

66. (canceled)

67. (canceled)

68. (canceled)

69. An aircraft comprising:
a fuselage;
a pair of wings attached to the fuselage;
at least one engine;
a plurality of control surfaces; and
a system for automatically compensating control of an aircraft for turbulence, the system including:
an optical sensor configured to sense speed of air relative to an aircraft at a predetermined distance in front of an aircraft;
storage media that stores control laws for the aircraft; and
a processor coupled to receive the sensed speed of air from the optical sensor and the control laws from the storage media, the processor including:
a first component that determines whether the sensed speed of the air at the predetermined distance is indicative of turbulence; and
a second component that applies the sensed speed of the air at the predetermined distance to the control laws of the aircraft to automatically generate control signals that configure the aircraft to compensate for the turbulence by a time the aircraft enters the turbulence.

70. The aircraft of claim 69, wherein the control signals automatically cause flight control surfaces to be positioned to compensate for the turbulence by the time the aircraft enters the turbulence.

71. (canceled)

72. An aircraft comprising:
a fuselage;
a pair of wings attached to the fuselage;
at least one engine;
a plurality of control surfaces; and
a system for automatically compensating control of an aircraft for wind shear, the system including:
an optical sensor configured to sense speed of air relative to an aircraft at a predetermined distance in front of an aircraft;
storage media that stores control laws for the aircraft; and
a processor coupled to receive the sensed speed of air from the optical sensor, the processor including:
a first component that determines whether the sensed speed of the air at the predetermined distance is indicative of wind shear;
a second component that applies the sensed speed of the air at the predetermined distance to the control laws of the aircraft; and
a third component that modifies the control laws of the aircraft to which the sensed speed of the air at the predetermined distance has been applied to automatically generate control signals that configure the aircraft to compensate for the wind shear by a time the aircraft enters the wind shear.

73. The aircraft of claim 72, wherein the control signals automatically cause engine thrust to be increased to compensate for the wind shear by the time the aircraft enters the wind shear.

74. (canceled)

75. An aircraft comprising:
a fuselage;
a pair of wings attached to the fuselage;
at least one engine;
a plurality of control surfaces; and
a system for automatically compensating control of an aircraft for turbulence or clear air turbulence or wind shear, the system including:
a sensor configured to sense speed of air relative to an aircraft at a first predetermined distance in front of the aircraft and at a second predetermined distance that is further in front of the aircraft than the first predetermined distance;
storage media that stores control laws for the aircraft; and
a processor coupled to receive the sensed speed of the air from the sensor, the processor including:
a first component that determines whether the sensed speed of the air at the first predetermined distance is indicative of turbulence, the first component further determining whether the sensed speed of the air at the second predetermined distance is indicative of clear air turbulence or wind shear; and
a second component that applies the sensed speed of the air at the first and second predetermined distances to the control laws of the aircraft to automatically generate control signals that configure the aircraft to compensate for the turbulence or clear air turbulence or wind shear by a time the aircraft enters the turbulence or clear air turbulence or wind shear.

76. The aircraft of claim 75, wherein the control signals automatically cause flight control surfaces to be positioned to compensate for the turbulence by the time the aircraft encounters the turbulence.

77. The aircraft of claim 75, wherein the control. signals automatically cause engine thrust to be increased to compensate for clear air turbulence by the time the aircraft enters the clear air turbulence or wind shear.

78. The aircraft of claim 75, wherein the sensor includes an optical sensor.

79. The system of claim 41, wherein the third component modifies the control laws of the aircraft to which the sensed speed of the air at the predetermined distance has been applied with a pair of gain factors.

80. The system of claim 79, wherein each of the pair of gain factors is a function of at least one variable chosen from aircraft velocity and aircraft altitude.

81. The system of claim 79, wherein one of the pair of gain factors is a function of aircraft weight and the other of the pair of gain factors is a function of aircraft configuration.

82. The aircraft of claim 72, wherein the third component modifies the control laws of the aircraft to which the sensed speed of the air at the predetermined distance has been applied with a pair of gain factors.

83. The aircraft of claim 82, wherein each of the pair of gain factors is a function of at least one variable chosen from aircraft velocity and aircraft altitude.

84. The aircraft of claim 82, wherein one of the pair of gain factors is a function of aircraft weight and the other of the pair of gain factors is a function of aircraft configuration.
